(19) United States
(12) Patent Application Publication
(10) Pub. No.: US 2014/0279925 A1
(43) Pub. Date: Sep. 18, 2014

(54) POPULATION OF DATA IN A SPIRITUAL RESEARCH DATABASE SYSTEM AND METHOD

(71) Applicants: Andrew Grossman, Hopkins, MN (US); Kenneth F. Krutsch, Minnetonka, MN (US); Richard Monson-Haefel, Edina, MN (US); Clayton Darwin, Comer, GA (US)

(72) Inventors: Andrew Grossman, Hopkins, MN (US); Kenneth F. Krutsch, Minnetonka, MN (US); Richard Monson-Haefel, Edina, MN (US); Clayton Darwin, Comer, GA (US)

(73) Assignee: Ambient Consulting, LLC, Minneapolis, MN (US)

(21) Appl. No.: 13/834,065

(22) Filed: Mar. 15, 2013

Related U.S. Application Data
(63) Continuation-in-part of application No. 13/833,340, filed on Mar. 15, 2013.
Application No. 13/833,340 is a continuation-in-part of application No. 13/832,249, filed on Mar. 15, 2013.

(51) Int. Cl. G06F 17/30

(52) U.S. Cl. CPC G06F 17/30312
USPC 707/662

(57) ABSTRACT

A computerized system and method are presented that utilize the assistance of subject matter experts to create a research archive for researching fundamental texts of a variety of spiritual and religious domains. Using a subject matter expert interface that provides tools not available to users of the archive database, the subject matter experts identify ideas having snippets from the fundamental texts. Each idea is associated with a single life issue tag and a religious or spiritual domain. Through the subject matter expert tools, subject matter experts are requested to provide commentaries that comment on the snippet from the point of view of the religious domain and its relationship to the associated life issue tag. The commentaries are each written with respect to a particular role.

### CROSS REFERENCE TO RELATED APPLICATION

This application is a continuation-in-part of U.S. patent application Ser. No. 13/833,340, filed Mar. 15, 2013, which is itself a continuation-in-part of U.S. patent application Ser. No. 13/832,249, filed Mar. 15, 2013, both of which are hereby incorporated by reference in its entirety.

### FIELD OF THE INVENTION

The present application relates to the field of computerized systems that automate the process of spiritual research.

### SUMMARY

An embodiment of the present invention provides one or more server computer systems that provide access to a research archive for researching fundamental texts of a variety of spiritual and religious domains.

### BRIEF DESCRIPTION OF THE DRAWINGS

FIG. 1 is a schematic diagram showing a server capable of implementing a research archive of the present invention in the context of a larger system.

FIG. 2 is a schematic diagram showing the major components of an archive server computer.

FIG. 3 is a schematic diagram showing a portion of a hierarchy of life issue tags.

FIG. 4 is a schematic diagram showing a portion of a hierarchy of domains.

FIG. 5 is a schematic diagram showing an example idea in the context of the related database entities.

FIG. 6 is a flow chart showing a system of the creation of new synonyms based on user interaction.

FIG. 7 is a schematic diagram showing related synonyms for a life issue tag along with suggested synonyms to be presented to a subject matter expert.

FIG. 8 is a flow chart showing a method of searching for and presenting ideas from a research archive.

FIG. 9 is a schematic diagram showing a user interface for presenting ideas in response to a search.

FIG. 10 is a schematic diagram showing a user interface for presenting an idea within its research archive context.

FIG. 11 is a flow chart showing a method to define domains in an archive database.

FIG. 12 is a flow chart showing a method to define life issue tags in the archive database of FIG. 11.

FIG. 13 is a flow chart showing a method to define corpora for domains in the archive database of FIG. 11.

FIG. 14 is a flow chart showing a method to define snippets and assign life issue tags to ideas in the archive database of FIG. 11.

FIGS. 15 and 16 are flow charts that separately show methods to define snippets and assign life issue tags to ideas in the archive database, respectively.

FIG. 17 is a flow chart showing a method to create commentaries in the archive database of FIG. 11.

### DETAILED DESCRIPTION

### System Overview

FIG. 1 shows the major elements of a system 100 in which the present invention can be used. In the embodiment shown in FIG. 1, the computerized system 100 utilizes three separate server systems, namely an archive server 110, a spiritual community server 120, and a personal reflections book server 130. Each of these servers 110, 120, 130 uses a set of software instructions or interfaces stored on a non-volatile, non-transitory, computer readable medium 112, 122, 132, respectively, such as a hard drive or flash memory device. A programmable digital processor 114, 124, 134, such as a general purpose CPU manufactured by Intel Corporation (Mountain View, Calif.) or Advanced Micro Devices, Inc. (Sunnyvale, Calif.), accesses and performs the software. To improve efficiency, the processors 114, 124, 134 may load software stored in memory 112, 122, 132 into faster, but volatile RAM 116, 126, 136. Data operated upon by the software can also be stored in non-volatile memory 112, 122, 132 and retrieved into RAM 116, 126, 136 for analysis, recording, and reporting. The software typically includes operating system software, such as LINUX (available from multiple companies under open source licensing terms) or WINDOWS (available from Microsoft Corporation of Redmond, Wash.).

Each of the server systems 110, 120, 130 further includes a network interface 118, 128, 138 to communicate with other computerized devices across the digital data network 150. In one embodiment, the network 150 is wide area network such as the Internet or a TCP/IP-based Intranet, and the network interfaces 118, 128, 138 each include TCP/IP protocol stacks for communicating over the network 150. The network interfaces 118, 128, 138 may connect to the network 150 wirelessly or through a physical wired connection. The network interfaces 118, 128, 138 can also be used to provide communication between the servers 110, 120, 130, such as over a local area network 140.

The computerized system 100 is shown in FIG. 1 as three separate server systems 110, 120, 130 to emphasize the distinct services provided by each of these systems 110, 120, 130. Each of these separate server systems 110, 120, 130 can be implemented on a single computer with a single processor 114, 124, 134. Alternative, each server system 110, 120, 130 could also implemented using a network of computers all operating according to the instructions of the software. In fact, the entire system 100 could easily be implemented on a single computer system using one or more processors.

The computerized system 100 provides access to data on the servers 110, 120, 130 over the network 150 to a user computer system 160. The user computer system 160 could be similar in construction to the server systems 110, 120, 130 that make up system 100, utilizing a general-purpose processor such as those provided by Intel Corporation or Advanced Micro Devices. Alternatively, the user computer system 160 could be a portable computing device such as a tablet computer or smart phone. These kinds of devices generally use specific operating systems designed for mobile devices, such as iOS from Apple Inc. (Cupertino, Calif.) or ANDROID OS from Google Inc. (Menlo Park, Calif.), and also frequently use mobile specific processors, such as those designed by ARM Holdings (Cambridge, UK). The user computer system 160 allows a user to access and update the data found on the servers 110, 120, 130.

In addition, the computerized system 100 provides access to the data on the servers 110, 120, 130 to a subject matter expert (or “SME) computing system 170. Like the user computer system 160, the SME computing system 170 could be a general-purpose computer or a mobile device. Also like the user computer system 160, the SME computing system 170 accesses and updates the data found on the servers 110, 120, 130. The SME computing system 170 differs from the user computing system 160 in the type of access provided to the data. The SME computing system 170 is usable only by experts in the religious and spiritual subject matters that are found in the servers 110, 120, 130. The system 100 grants these experts the ability to add and change data in the system 100 that is not alterable by other users.

Each server system 110, 120, 130 manages a database and provides interfaces to the database to one or more user computing systems 160 over the network 150. The archive server 110 contains data about spiritual texts and life issues. This data is sometimes referred to herein as the “research archive.” The spiritual texts are taken from a variety of spiritual and religious beliefs referred to herein as domains. One of the primary data elements maintained by the archive server 110 is an “idea.” Each idea contains or refers to a snippet or quotation from a spiritual text that is considered a foundational text for one of the domains of the research archive. Each idea also contains or refers to a set number of commentaries on the snippet. The commentaries are written from the point of view of a particular domain, and each commentary is written in the context of a particular approach to that domain. Furthermore, each idea approaches the snippet of text in the context of a particular life issue. Life issues are organized as tags within a life issue tag hierarchy maintained by the archive. This is described in more detail below in connection with FIGS. 2 and 3.

The spiritual community server 120 provides a social networking space to the user computer 160 organized around community spaces. Community spaces may have closed memberships to outsiders, creating social networking areas that are open only to a defined constituency. Examples include clergy spaces that are open only to clergy of a particular denomination and congregational spaces open only to known members of a spiritual congregation. Members of these communities use the spiritual community server 120 to engage with each other over spiritual issues.

The personal reflections book server 130 provides the user computing device 160 with the resources necessary to plan, document, and contemplate a personal life journey. The personal reflections book server 130 allows a user to record thoughts and actions, and plan for future actions and deeds. The personal reflections book server 130 is deeply integrated into the archive provided by the archive server 110, allowing research into the archive to place meaning on the events and beliefs recorded through the personal reflections book server 130.

The computer system 100 monitors users in all three aspects of the system 100. This allows the system 100 to track behavior and movement within the system, and to present suggestions for consideration by the users. A user struggling with a life issue using the personal reflections book server 130 could be identified by the system 100, and related ideas from the archive server 110 could be suggested to the user. Alternatively, the system could recommend conversations or other interactions maintained by the spiritual community server 120 that are related to that struggle. Paths taken by a user through the system 100 can be recorded, and outcomes of various struggles, decisions, and life events could be determined. This data could be aggregated to remove personally identifying information and then shared with other users, researchers, and educational and spiritual institutions. More information about the spiritual community server 120 and the personal reflections book server 130 can be found in the parent patent application incorporated above.

### Archive Structure

The archive server 110 of FIG. 1 can be implemented as one or more web server computers 220 communicating with a user computer 200 and a subject matter expert computer 204 over the World Wide Web 210, as shown in FIG. 2. The archive server computer 220 uses a processor 230, a network interface 240, and web programming 250 to provide web-based interfaces over the web 210. The user interface 202 provides the ability to access the research archive that is stored and managed by the archive server 220. The SME interface 206 provides expert tools to the SME computer 204 that allows the SME interface 206 to alter the research archive in order to include the subject mater expertise of the expert using the SME interface 206. These expert tools are not made available to users of the user interface 202. The research archive is also accessed and used by the spiritual community server 120 and the personal reflections book server 130.

In the preferred embodiment, the archive server computer 220 stores the research archive in a structured database 260. The archive can be maintained as separate tables in a relational database, or as database objects in an object-oriented database environment. The database 260 is stored in the memory of the research archive server computer 220 as data and related database programming. The database programming directs the processor 230 to access, manipulate, update, and report on the data in the database 260 as further described herein. FIG. 2 shows the database 260 with tables or objects for a life issue tags 270, ideas 280, and domains 290. Relationships between the database entities, including entities 270, 280, and 290 are represented in FIG. 2 using crow's foot notation. For example, FIG. 2 shows that a life issue tag 270 may be related to (or “associated with”) multiple ideas 280, but each idea 280 is associated with only a single life issue tag 270. Associations or relationships between the database entities shown in FIG. 2 can be implemented through a variety of known database techniques, such as through the use of foreign key fields and associative tables in a relational database model. In FIG. 2, associations are shown directly between two database entities, but entities can also be associated through a third database entity. For example, a snippet database entity 282 is directly associated with an idea database entity 280, and through that relationship the snippet entity 282 is also associated with a life issue tag database entity 270 and a domain database entity 290.

The life issue tag database entity 270 contains an identifier and a description for a particular life issue that may face an individual, such as “marriage” or “death of a parent.” The life issue tags 270 are organized within a life issue tag hierarchy 272 maintained by the archive database 260. This means that each tag 270 may be assigned one or more child tags 270 through the use of a child relationship 274. It is to be understood that the hierarchy 272 could be created with a parent relationship instead of a child relationship 274, or by using both child 274 and parent relationships. Within the life issue tag hierarchy 272, individual tags 270 may have a parent tag 270, one or more sibling tags 270, and one or more child tags 270. FIG. 3 shows one portion of an example life issue tag hierarchy 300. In this example, tag 310 deals with the life issue of relationships. Two child tags 320, 322 of the relationships tag 310 are shown in FIG. 3, namely the marriage tag 320 and the parent/child relationship tag 322. The marriage tag 320 is itself shown with seven child tags 330-342, namely a fidelity tag 330, a weddings tag 332, a children in marriage tag 334, a death of a spouse tag 336, a support of family tag 338, an in-laws tag 340, and a divorce tag 342. In this hierarchy 300, the marriage tag 320 has one parent tag 310, one sibling tag 322, and seven child tags 330-342. The fidelity tag 330 has one grandparent tag 310, one parent tag 320, and six sibling tags 332-342. The parent 320 and grandparent tag 310 can both be considered ancestor tags of the fidelity tag 330. Similarly, all of the tags assigned reference numerals 320-342 are progeny tags of the relationship tag 310.

In one embodiment, every tag 310-342 has only a single parent tag and therefore is found in only one location in the hierarchy 300. In other embodiments, a single tag 330-342 may have multiple parents and can therefore be duplicated at multiple locations in the hierarchy 300. For example, the death of a spouse tag 336 could be a child tag to the marriage life issue tag 320, and could also be a child tag to a “death” life issue tag (not shown in FIG. 3). In some embodiments, every time a data element is associated with a life issue tag 270 it is automatically associated with the parent of that life issue tag 270, or even all ancestors of that tag 270. For instance, content assigned to the in-laws tag 340 would automatically be assigned to the marriage tag 320 and the relationship tag 310.

Returning to FIG. 2, the research archive database 260 can contain one or more synonym data base entities 276 that are associated with each life issue tag 270. This allows the user interface 202 to accept a key word search for a particular life issue tag 270. The content of the life issue tag entities 270 and the synonym entities 276 can then be searched for occurrences of those key words. If the key words were not found in the title or description of any of the life issue tags 270 but were found in the synonyms 276, the appropriate life issue tags 270 could still be identified by identifying the life issue tags 270 associated with the found synonyms 276. This is described in more detail below in connection with FIG. 6.

The idea database entities 280 each reference a single snippet or quotation 282 from a spiritual text 288 that is considered a foundational document for one of the domains 290 of the archive database 260. The domains 290 are categorizations of spiritual or religious bodies or groups of believers, such as Sufism, Southern Baptist, or Catholic. Domains are identified through the domain database entity 290. As was the case with life issue tags 270, the archive database 260 maintains a hierarchy of domains 292 by assigning a child relationship 294 between one domain and another. FIG. 4 shows one portion of an example domain hierarchy 400. The top domain 290 shown in this section of the hierarchy 400 is Christianity 410. This domain 410 has two children, namely western Christianity 420 and eastern Christianity 422. Western Christianity 420 has two child domains 290 in hierarchy 400, namely Catholic 430 and Protestant 432. The Protestant domain 432 itself has six children, namely Anglican 440, Presbyterian 442, Methodist 444, Lutheran 446, Baptist 448, and Reformed 450. Each of these children domains 440-450 could itself be a parent domain 290 for other recognized religious domains 290. As was the case with the life issue tag hierarchy 300, domains 410-450 in the domain hierarchy 400 can have ancestor domains (parents, grandparents, etc.) and progeny domains (children, grandchildren, etc.).

FIG. 2 shows that each domain 290 is associated with a plurality of spiritual documents 288, with the documents 288 that are associated with a single domain 290 constituting the “corpus” for that domain 290. These documents 288 were selected by subject matter experts using interface 206 as a representative group of spiritual documents 288 for that domain 290. Not surprisingly, the documents 288 can be assigned to multiple domains 290, as numerous religious and spiritual domains 290 share spiritual documents 288 with other domains 290. Each snippet 282 is a quotation or an excerpt from a spiritual document 288. Every document 288 can have multiple snippets 282, but every snippet 282 is taken from only one document 288.

Each idea 280 is associated with a single life issue tag 270, with a single domain 290, and with a single snippet 282 that is taken from a document 288 associated with that domain 290. Consequently, although each idea 280 is related to only a single life issue tag 270, snippet 282, and domain 290, multiple ideas 280 can exist for a single life issue tag 270, snippet 282, or domain 290. Each idea 280 is also associated with a set of commentaries 284. These commentaries are written by subject matters experts, each of whom is identified and tracked through a subject matter expert database entity 286. Each subject matter expert is an expert on at least one religious or spiritual domain 290, as indicated by the relationships between database entities 286, 290 shown in FIG. 2. The subject matter experts write the commentaries 284 on the snippet 282 for an idea 280 from the point of view of the idea's domain 290. These commentaries 284 also reflect on how the snippet 282 relates to the life issue tag 270 assigned to that idea 280. Each of the set number of commentaries 284 associated with an idea 280 are written in the context of a particular approach to the related domain 290 as indicated by the role 281 assigned to that commentary 284. For instance, five commentaries 284 on the snippet 282 could be written from the point of view (or role 281) of i) a historical analysis approach within the domain 290, ii) a traditional approach within that domain 290, iii) a moderate approach within the domain 290, iv) a modern approach within the domain 290, and v) a comparative approach comparing the understanding of the associated domain 290 with other domains 290. In the preferred embodiment, all ideas 280 in the archive database 260 contain the same number of commentaries 284 (such as four, five, or six) on the snippet 282, with the commentaries 284 all written from the same four (or five or six) different roles 281. The roles 281 can be implemented in a variety of ways, such as by identifying the role 281 in the database structure that creates the relationship between the idea 280 and the commentary 284. Alternatively, the commentary database entity 284 could contain data identifying its role, or the idea database entity 280 could be constructed to have separate, single relationships defined for each of the possible roles 281.

FIG. 5 shows some example data 500 in the research archive database 260. In this case, a single idea 280 is diagrammed. This idea 280 is associated with the life issue tag 270 of “afterlife.” This life issue tag 270 is in a life issue hierarchy 272, and is shown as a child of the parent tag “death” 271. A synonym 276 has been assigned to the life issue tag 270, in this case allowing searches for the word “afterworld” to be associated with the life issue tag afterlife 270. The idea is also associated with a snippet 282, in this case chapter 3, verse 16 of the Gospel of St. John. This snippet 282 is taken from a document 288, in this case the protestant Bible. This document 288 is associated with a particular domain 290, in this case the Anglican domain 440, which is a child of the Protestant domain 432.

The idea 280 in FIG. 5 contains five commentaries 284 that provide expert commentary on the snippet 282. All of the commentaries 284 are written from the point of view of the Anglican domain 290, and all of the commentaries 284 reflect on how this snippet 282 relates to the life issue 270 of the afterlife. The five commentaries differ in their roles 281, approaching the same question from the five pre-defined roles: i) an Anglican historical analysis approach, ii) a traditional Anglican approach, iii) a moderate Anglican approach, iv) a modern Anglican approach, and v) a comparative approach comparing the Anglican understanding with other domains 290.

Of course, the table or object entities shown in FIGS. 2-5 should not be considered to show actual implementation details of the database 260, since it is well within the scope of the art to implement this type of data using a variety of entity architectures. The entities shown are exemplary, intended to aid in the understanding of the data maintained by the system database 260 in this embodiment. It is not even necessary to implement these entities as formal tables or objects, as other database paradigms could also effectively implement these types of data structures. Throughout the remainder of this disclosure, the content and interrelationship of database structures will continue to be explored using these example data structures, but these structures should not be considered to limit the way in which these databases can be constructed.

### Searching and Displaying of Results

One benefit of this construction of the archive database 260 is that it is possible to research the ideas 280 and document snippets 282 by identifying a life issue tag or tags 270 of interest. FIG. 6 shows a process 600 by which a user can enter a search phrase and find related ideas 280, document snippets 282, and commentaries 284, and even if the words used in the search phrase were not found in any of these elements 280, 282, 284. The process 600 starts at step 610 where a user enters a search phrase using the user interface 202 provided by the research archive server computer 220. The server computer 220 then uses the search phrase to identify life issue tag database entities 270. These database entities 270 may contain one or more fields that define a life issue tag, such as a life issue tag name (e.g., “marriage”) and a life issue tag description (“this tag relates to issues concerning two people joined together in marriage”). Step 620 can search all fields in the life issue tag database entity 270 for a match to the search phrase.

At step 630, the synonym database entities 276 are then compared to the search phase to find matching synonyms. If a match is found between the search phrase and the synonyms 276, then the related life issue tag 270 is identified for the matching synonym 276. For example, FIG. 7 shows five synonyms 710-718 that have been assigned in the database 260 to the life issue tag of marriage 320. Using these synonyms 710-718, a search phrase that includes any of the words “matrimony,” “wedlock,” “wedded,” “espoused,” or “union” would be linked to the life issue tag 320 of “marriage.”

At step 635, the system 100 determines a level of confidence for the life issue tag(s) 270 identified in steps 620 and 630. This level of confidence can be based on the closeness of the match between the search phrase and the life issue tag data in step 620 or between the search phrase and the synonym in step 630. If the match is very close or exact, the level of confidence is high and the method proceeds to step 640. At this step, the total number of life issue tags 270 found through steps 620 and 630 are identified. If only one life issue tag 270 was identified, then the process continues at step 650 where the results for the one discovered life issue tag 270 displayed to the user interface 202. These results include the presentation of the identified life issue tag 270 within its location in the life issue tag hierarchy 272, as well as a listing of idea database entities 280 that are associated with that life issue tag 270. One process 800 for selecting and organizing these idea database entities 280 after a search is shown in FIG. 8 and described below. If more than one life issue tag 270 were identified by the by step 640, it would be possible to simply list all of the identified life issue tags 270 and allow the user to select their desired tag 650. Process 600 operates differently, in that the discovered life issue tags 270 are ranked according to a ranking algorithm at step 660, and then the highest ranked tag 270 in the ranking is identified at step 670 for use in the display step 650. The ranking algorithm used in step 660 can use a variety of ranking algorithms that are known in the prior art. For instance, the tags 270 could simply be ordered in terms of their popularity. Tags 270 that are viewed more frequently than other tags 270 by the users of server computer 220 would be ranked higher than others. More sophisticated algorithms could also be used, such as algorithms that track the activities and behaviors of previous users who have submitted similar search phrases to determine which results have been most useful to users.

If step 635 indicates that the level of confidence in the discovered life issue tag(s) 270 is low, or if no tags were discovered in steps 620 and 630, then an additional process begins at step 680. The process splits at point 636, because step 680 will occur in parallel with steps 640-670 described above. The split occurs because the system 100 realizes that it may not have found a good match among the life issue tags 270 or their synonyms 276 for the search phrase. As a result, the system 100 begins to track user activity in step 680 in order to help identify which life issue tag 270 is the best fit for this search phrase. The expectation is that the user will continue to perform searches or navigate the life issue tag hierarchy 272 until the user discovers the life issue tag 270 that best meets their needs. When the system 100 notes that the user appears to be examining ideas 280 for a particular life issue tag 270, the system identifies this tag 270 as a potential synonym for the search phrase at step 682. For instance, if the user had entered “engagement” as the search phrase and this word was not found in the life issue tag database entities 270 or the synonyms 276, no results might have been available for display to the user. The user might nonetheless navigate the life issue tag hierarchy until they found the life issue tag 270 of “marriage.” When the user starts to investigate ideas 280 associated with this life issue tag 270, step 682 will identify the word “engagement” as a potential synonym for the “marriage” life issue tag 270.

In order to ensure the accuracy of the archive database 260, potential synonyms found by step 682 are not automatically added to the database 260. Instead, the system 100 requests assistance of a subject matter expert through the SME interface 206. At step 684, the system 100 presents the proposed synonym and any other proposed synonyms found by step 682 to the SME interface 206. For example, FIG. 7 shows two proposed synonyms 276 that step 682 might have discovered, namely “sacrament” 720 and “engagement” 722. At step 686, the SME interface 206 receives either a validation or a rejection of each proposed synonym 720, 722. For example, the subject matter expert may agree that “engagement” is adequately similar to the life issue tag 270 of “marriage” so as to qualify as a synonym 276 in the archive database 260. However, although marriage is considered a sacrament in some traditions, the expert may not feel that the archive database 260 would be well served by adding “sacrament” as a synonym 276 of the marriage life issue tag 270 and therefore would reject this proposed synonyms 720. If the SME interface 206 provides a validation of the proposed synonym 720, 722, it is added as a synonym 276 in the archive database 260 at step 688. If the SME interface 206 returns a rejection, step 688 is skipped. Although FIG. 6 shows this stage in the process ending if step 688 is skipped, in one embodiment the synonym is saved for later review. If the same synonym 276 appears for this life issue tag 270 in the future based on the activity of a different user, this synonym 276 could be re-submitted for analysis as a potential synonym 276.

FIG. 8 shows a process 800 for gathering, filtering, and sorting idea database entities 280 that are associated with a particular life issue tag 270. Process 800 begins with step 810, in which a request to present ideas 280 for a particular life issue tag 270 is received. This request can come from process 600, which includes a step to display the ideas 280 associated the found life issue tag 270 at element 650. This request can also come from other aspects of the user interface 202, as is described below.

Using the associations (or relationships) established by the database 260 between life issue tags 270 and ideas 280, the process 800 can easily identify those ideas 280 associated with the identified life issue tag 270 in step 820. In some circumstances, it may be helpful to gather additional ideas 280 beyond those that are directly associated with the identified life issue tag 270. If these additional ideas 280 are to be gathered, as determined by step 830, step 832 identifies children life issue tags 270 of the identified life issue tag 270, and then identifies the ideas 280 that are associated with these children tags. Similarly, step 834 identifies parent life issue tags 270 and identifies ideas 280 associated with these parent tags 270. In step 836, the system 100 uses an analysis of past user behaviors in order to predict other life issue tags 270 that may be of interest to a user. For instance, the system may have identified a pattern showing that users that research “marriage”, “fidelity,” and “divorce,” life issue tags also frequently research ideas 280 related to the life issue tags 270 of “anger” and “reconciliation.” By analyzing the current user's research behavior, the system 100 may identify these other tags 270 that may be of interest. These system-identified tags 270 can then be used at step 836 to identify additional ideas 280 for presentation to the user.

At step 840, the process 800 determines whether the gathered ideas 280 are to be filtered according to the domains 290 that are assigned to each idea 280. In some circumstances, no filtering will be done and the process 800 continues to the sorting steps 850-864. In other circumstances, a user may have self-identified themselves to the system 100 as a believer or practitioner of a particular spiritual or religious domain 290. If the user desires, their research of the archive database 260 will be limited only those ideas 280 that are associated with the user's chosen domain 290. In this circumstance, step 842 will filter the ideas 280 to include only those associated with the user's domain 290. In other circumstance, multiple domains 290 will be acceptable to a user but the user does not desire all domains 290 to be included in their research. For example, a self-identified Anglican may desire to include ideas associated with child domains 290 of the Anglican domain, which may include an Episcopal Church of the USA domain 290, a Church of England domain 290, an Anglican Church of Australia domain 290, and numerous other domains 290. Step 844 will filter the gathered ideas 280 according to the user selected plurality of domains 290. In some embodiments, ideas 280 associated with child domains 290 are automatically associated with parent domains 290, such that all ideas 280 associated with any Christian domain 290 would be selected if a user elected to view ideas associated with the Christianity domain 290. Step 844 may also be used to filter ideas 280 against multiple, unrelated domains 290. For instance, a self-identified “Anglican” may indicate in their preferences that they also wish to review ideas 280 stemming from two unrelated spiritual disciplines each having their own domain 290.

At this step 850, the process 800 selects one or more sorting methods 852-864 to sort the remaining ideas 280 so as to give preferences to those ideas 280 that are most likely to be of interest to the user. For example, if the user did not filter the ideas 280 by domain 290 but nonetheless indicated a preference for one or more particular domains 290, the ideas 280 could be sorted according to those preferred domains 290 at step 852. These preferences could have been manually set by the user using the user interface 202, or could have been identified by the system 100 by tracking past user behavior. For example, a user that has previously only viewed ideas in the Anglican domain 290 and the New Age Mysticism domain 290 would have the ideas 280 sorted at step 852 so that ideas 280 in those identified domains 290 appear first in the result list presented to the user. In the same way, a user could indicate a preference for a particular document (e.g., the protestant Bible), a favorite author (Martin Luther), or a favorite subject matter expert that writes commentaries 284 for ideas 280, which could cause the process 800 to sort the ideas by that document (step 854), author (step 856), or subject matter expert (step 858). In addition, the system 100 could allow users to rate particular ideas 280, and can then sort the ideas 280 at step 860 in order to present the ideas 280 in order of their user ratings.

At step 862, the system 100 attempts to assign determine whether users searching the archive database 260 have achieved a successful outcome. A successful outcome may mean that the user repeatedly returns to the same idea 280 when researching a life issue tag 270, or that the user quoted content from an idea 280 in contributions that the user made to the spiritual community server 120 or the personal reflections book server 130. However success is measured, the system 100 can identify ideas 280 that have helped users reach a successful outcome, and then sort the resulting ideas 280 according to that success measurement.

Finally, the system 100 can attempt to create a best guess of those ideas 280 that would be most useful to the current user and then present those ideas 280 first in the user interface 202. Step 864 differs from step 862 in that step 862 tried to determine which ideas 280 were most successful to all users, while step 864 attempts to determine the best ideas 280 for the particular user that will view the result. In one embodiment, step 864 first determines relevant life issue tags 270 and domains 280 for a user, either through user-set preferences or by watching user interaction with the system. The system the identifies previous users that shared these life issue tags 270 and domains 280 and determines which ideas 280 were most popular or useful to these previous issues and then sorts the ideas 280 accordingly.

There is no need to use only a single one of these identified sorting techniques 852-864. Multiple techniques 852-864 could be combined to create a primary and secondary sort for the ideas 280. Once the ideas 280 are sorted, the sorted ideas 280 are presented to the user through the user interface 202 at step 870, which is described in more detail in connection with FIG. 9.

### Presentation on the User Interface

In response to a search request by a user, a life issue tag 270 is identified through process 600, and then ideas 280 associated with the identified life issue tag 270 are gathered, filtered, and sorted in process 800, and the results are presented to a user such as through user interface 900 shown in FIG. 9. This interface has three main parts: a life issue hierarchy portion 910 that is responsible for displaying the selected life issue tag 270 in the context of its tag hierarchy 272, a related idea presentation portion 930 that presents sorted ideas 280 that are associated with the selected life issue tag 270 and perhaps related tags 270 in the tag hierarchy 272, and a best guess portion 970 that presents ideas 280 that are not directly related to the presented life issue tag 270 but may be of interest to the user.

The life issue hierarchy portion 910 shows the identified life issue tag 270 from method 600. In this case, the identified tag is the marriage tag 920. In interface 900, this tag 920 is placed in the center of the life issue hierarchy portion 910 and is emphasized such as through the use of bolded or larger text. This emphasis lets the user understand that this interface 900 is centered on the life issue tag of marriage 920. The tag hierarchy portion 910 of interface 900 includes not only the identified tag 920, but also the parent of this tag (the relationships tag 922) and at least one child tag (the fidelity tag 924). In some embodiments, all children tags are shown in the life issue hierarchy portion 910 of the user interface, as is indicated by showing a second child tag (the weddings life issue tag 926) in dotted lines on FIG. 9. In order to show numerous children tags 924, 926 of the selected tag 920, it is sometimes helpful to design the interface 900 such that the tag hierarchy is positioned vertically along the left side of the interface 900 as opposed to horizontally on the top side of the interface 900 as shown in FIG. 9.

By presenting the life issue hierarchy portion 910, a user is able to directly traverse the life issue tag hierarchy 272 starting at the life issue tag 920 selected by their search. In one embodiment, the user simply clicks on the desired life issue tag 270 shown in portion 910 and interface 900 is refreshed with the chosen tag 270 becoming the centered, identified tag 920 of the interface 900. The user can traverse up and down the hierarchy 272 without selecting a particular tag 270 using the arrows 912, 914 included in interface portion 910.

Sometimes a user's search phrase will identify more than one life issue tag 270. As discussed above, method 600 will then rank the tags and select the most likely tag in steps 660 and 670. For example, an individual might have searched on the word “unions.” This word was identified as a synonym 718 of the life issue tag “marriage” 320 as shown in FIG. 7. However, it is possible that the same word “union” was also considered a synonym for the life issue tag of “alliances.” While method 600 ranked the tags 270 and selected the marriage tag 920 as the preferred tag 270 to display on interface 900, the interface 900 may present the user with the opportunity to select the un-selected tag. This is done with question 916, which allows the user to automatically select the alliances life issue tag 270 and refresh interface 900 around that tag.

The related idea presentation area 930 is shown in FIG. 9 with three columns 940, 950, 960 of ideas. The main column 940 is placed in the center of interface 900 directly underneath the identification of the main life issue tag 920 for interface 900. The ideas 942, 944, 946 in this column 940 are emphasized to let the user know that these ideas 942, 944, 946 relate directly to the marriage life issue tag 920. These ideas 942-946 have been gathered, filtered, and sorted according to process 800. As shown in FIG. 9, these ideas 942, 944, 946 are not presented in their entirety (which would include the text of the snippet 282 and the commentaries 284 on the snippet 282). Rather, the interface 900 in FIG. 9 identifies each idea 942, 944, 946 by disclosing the document 288, a citation or other identifier for the snippet 282, and a user rating for that idea 280. In other embodiments, language from the snippet 282 could be included in FIG. 9 to allow the users to read all or part of the snippet 282 before viewing the entire idea 280.

The first column 950 in the idea presentation area 930 shows ideas 952, 954 that are associated with the parent life issue tag 922 of “relationships.” Again, interface 900 merely provides some information about these ideas 952, 954 without displaying the entire idea 280 (including the snippet 282 and the commentaries 284). Because these ideas 952, 954 are not associated with the main life issue tag 920 of the interface 900, these ideas 952, 954 are generally deemphasized when compared with the more central ideas 942, 944, 946 relating to marriage 920. The third column shows ideas 962, 964 associated with one of the children tags, in this case the “fidelity” life issue tag 924. By including columns 950, 960 of ideas 952, 954, 962, 964 of that are not directly related to the central life issue tag 920, the user is able to obtain a broader picture of the ideas 280 that are accessible through related life issue tags 922, 924. This encourages the user to explore the life issue tag hierarchy through hierarchy interface portion 910 by manually traversing the hierarchy 272, which will allow the user to more quickly focus in on the exact life issue tag 270 that they desire.

As explained above in connection with step 836, the system 100 may gather ideas 280 for presentation to the user that are not based on a selected life issue tag 270 and its neighbors in the tag hierarchy 272, but instead are based on its analysis of the behavior of other users that have characteristics similar to the current user. This allows the system to suggest an idea 280 that is associated with a “reconciliation” life issue tag even though the user has only researched the “marriage”, “fidelity,” and “divorce,” life issue tags 270. In interface 900, this best guess idea 972 is presented to the user in interface portion 970. This portion 970 is best separated from the related idea presentation portion 930 so that users do not believe that the idea 972 is connected directly to the identified life issue tag 920.

A user may select any of the ideas 942-946, 952-954, 962-964, and 972 for more detailed study in the idea user interface 1000 shown in FIG. 10. This interface 1000 presents both a single idea 280 but also information about the context 1002 of the displayed idea 280, including the life issue tag 270 and domain 290 assigned to the idea 280. In this case, the life issue tag is “marriage” 1010 and the domain is “Anglican” 1020. In some embodiments, the life issue tag 1010 is presented within its context of the life issue tag hierarchy 272, showing the parent tag 1012 (“death”) and its children tags 1014. Similarly, the domain tag 1020 can also be shown in the context of the domain hierarchy 292 including the parent domain 1022 (“Protestant”) and children domains 1024. The context 1002 of the idea 280 also includes an identification of the document 288 from which the snippet 282 was taken. In this case, the document 288 is the Protestant Bible (1040), and the snippet is the Gospel of St. Matthew, Chapter 19, verses 4-6 (1050). Frequently the spiritual documents 288 in the archive database 260 have known authors, so the context information 1002 also identified the author 1030 for the document 1040. The rounded icons shown in the context information 1002 indicate that a user may select these icons and go to related information. For instance, the user can select a life issue tag 1010, 1012, 1014 and go to interface 900 for that life issue tag. Alternatively, the user could select the document icon 1040 and view the entire contents of the document 1040, or select the “in context” icon 1052 and go directly to the location of the idea's snippet 282 within the full text of the document 288. The “next idea” button 1042 allows a user to automatically go to the next idea 280 with the document 1040 for this life issue tag 1010 as analyzed by this domain 1024.

Interface 100 presents the full text of the snippet 1060, and then presents the commentaries 1070-1074 that comment on this snippet 1060 in the context of this life issue 1010 for this domain 1020. As explained above, commentaries 284 are preferably associated with pre-defined roles 281, with each idea 280 containing a similar set of commentaries 284 having the same roles 281. In FIG. 10, only three commentaries 1070-1074 are shown. However, if the database 260 were established with a set number of roles 281, such as four, five, or six, then interface 1000 would present commentaries for all of the set number of roles 281. Each commentary 1070, 1072, 1074 is written by a subject matter expert using interface 206. These SMEs are identified through icons 1080, 1082, and 1084 so that users may identify the expert that writes the commentaries 1070-1074. The icons 1080-1084 themselves can be selectable by the user so that the user can go directly to related ideas that contain commentary by the same subject matter expert. Ideally, these icons 1080-1084 would also identify the subject matter expert, such as by name.

Although interface 1000 is designed to allow users to view a single idea 280, it is possible that the system 100 might suggest additional ideas 280 for study by a user based on their past interests and history using the system 100. These suggested ideas 1090, 1092 could be presented at the bottom of the interface 1000. If selected by a user, the interface 1000 would be refreshed to show the selected idea 1090 or 1092.

Users may view interface 1000 after selecting an idea 280 from the search results interface 900. In that case, an icon 1004 on the idea interface 1000 may allow the user to move easily to the next idea 280 discovered in the search results shown in interface 900. In addition, the user may be allowed to rate the idea 280 at interface element 1006. This user rating would allow the system 100 to rank this idea 280 relative to other ideas as discussed above. Finally, the system may allow users to rate or vote on commentaries 1070-1074 that have been written about a snippet 1060 for an idea 280 through interface element 1008. The votes on commentaries 1070-1074 may alter the order in which the commentaries 1070-1074 appear on interface 1000. Alternatively, a commentary 1070-1074 that consistent received negative votes may be flagged for review and removal by the system 100.

### Population of the Archive Database

The user interface 202 can submit queries to the archive database 260 and then review life issue tags 270 and ideas 280 as described above in connection with FIGS. 6-10. Subject matter experts identified through entities 286 use the SME interface 206 and tools provided therein to populate and maintain the archive database 260. For example, the method 1100 shown in FIG. 11 allows the subject matter experts to define and populate the domain hierarchy 292 of domain database entities 290. The method starts with step 1110, in which subject matter experts are identified from across many religious and spiritual backgrounds. The experts can be hired or retained as volunteers to help populate and maintain the archive database 260. To help track the activity of these experts, subject matter expert database entities 286 can be added to the archive database 260 so that each expert is associated with a single database entity 286. This allows individual experts to be identified when they access the database 260 over the SME interface 206. Thus, in step 1120, the system 100 creates a separate subject matter expert database entity 286 for each retained subject matter expert, and then controls access to the system 100 through the SME interface 206 to known experts, such as through a username and password scheme.

One of the first steps in creating the archive database 260 is to identify the spiritual domains 290 that will be analyzed. The subject matter expert is requested to assist in this process by providing a tool in the SME interface 206 that allows the subject matter expert to input suggested domains 290 at step 1130. This tool also allows the subject matter experts to organize the domains 290 into a domain hierarchy 292 of domains 290, which occurs at step 1140. The tool allows subject matter experts to start with broad domains 290, such as Islam and Christianity, and then subdivide these domains 290 in the hierarchy 292. The end or leaf nodes of the domain hierarchy 292 should exist where any further real-world subgroups of these leaf nodes would have a relatively common doctrine on major religious issues, as indicated at step 1150. The domain addition tool in the SME interface 206 ideally allows collaboration between multiple subject matter experts in order to achieve relative unanimity on the domain hierarchy 292. In some embodiments, only a subset of all possible spiritual domains 290 is represented in the database 260. For example, the database 260 may being operation covering only a subset of all possible domains 290, and then expand into additional spiritual or religious domains 290 over time.

It is also necessary to define the life issue tags 270 and the life issue tag hierarchy 272, which is accomplished in process 1200 shown in FIG. 12. In one embodiment, this process 1200 starts at step 1210 with a single individual, such as an administrator, developing a first draft of a life issue tag hierarchy 272 with a plurality of life issue tags 270. The first draft could also be created by a subject matter expert through the SME interface 206. Once the draft life issue tag hierarchy 272 is present in the database 260, tools provided through the SME interface 206 will allow subject matter experts to view the hierarchy 272 (at step 1220) and to suggest changes to the life issue tags 270 and the hierarchy 272 (at step 1230). Changes suggested by a subject matter expert are subject to acceptance or rejection of these changes by the other subject matter experts assisting in the development of the system 100. Consensus or majority vote can be used among the subject matter experts using the tools in the SME interface 206 to create a “final” life issue tag hierarchy 272 at step 1240.

This hierarchy 272 is labeled “final” because the hierarchy 272 is now in condition to be released to users over the user interface 202. However, it is likely that changes and improvements to the life issue tags 270 and hierarchy 272 will be needed. At step 1250, the system 100 accepts user suggests for changes to the tags 270 and hierarchy 272 through the user interface 202. These suggestions are not implemented immediately, but are fed back to the subject matter experts for review through tools provided by the SME interface 206 at step 1260. If the user suggestions are approved by the subject matter experts, the changes to the life issue tags 270 and hierarchy 272 are implemented in the database 260 at step 1270.

Method 1300 shown in FIG. 13 allows the subject matter experts to define the documents 288 that will be included in the archive database 260. In one embodiment, the documents 288 are selected to be representative of the teachings and thoughts of the individual domains 290 that are included in the archive database 260. Because the inclusion of the representative documents 288 for any domain 290 will be highly subjective, method 1300 attempts to regulate the process as much as possible. The method 1300 starts at step 1310, where a single leaf-node domain 290 from the domain hierarchy 292 is selected. In this embodiment of the present invention, only leaf-node domains 290 are directly assigned documents 288, snippets 282, ideas 280, and commentaries 284. Parent domains 290 of leaf-node domains 290 do not have any assignments made to them, but are maintained in the domain hierarchy for two reasons. First, maintaining the domains 290 in a hierarchy makes it easier to search for and identify domains 290 for subject matter experts and users alike. Second, it is possible to implement the system 100 where parent domains 290 inherit the assignments (i.e., ideas 280, documents 288, snippets 282, and commentaries 284) of their child domains 290. Thus ideas 280 for non-leaf-node domains 290 could still be analyzed using the processes described above even if no ideas 280 were directly assigned to such domains 290.

Once a leaf-node domain is selected at step 1310, a tool provided on the SME interface 206 allows the subject matter experts to suggest documents 288 for that domain 290 at step 1320. In some domains, it is likely that hundreds of real-world documents would be candidates for the documents 288 that are assigned to a domain 290 in the database 260. As a result, some embodiments of the present invention will artificially cap the documents 288 assigned to a domain 290 at a preset number, such as no more than ten documents 288 per domain 290. To select the documents 288 to be used in the archive database 260, the tool in the SME interface 206 allows the various subject matter experts to vote on particular documents 288 at step 1330. The system 100 will attempt to ensure that canonical texts, historically significant texts, and contemporary texts are all represented in the limited set of documents 288 for a domain 290. To accomplish this, the documents selected in step 1320 may be categorized (e.g., “canonical,” “historically significant,” and “contemporary”), and documents compete against other documents in their own category for inclusion in the database 260. Once a preliminary set of documents 288 are approved for a domain 290, all of the subject matter experts will be allowed input as to whether the chosen set of documents 288 is balanced and of sufficient diversity and size to represent the beliefs of the domain 290. The documents 288 should further represent the various religious divisions within the identified domain 290 (or else it may be appropriate to split the domain 290 into separate leaf-node subdomains 290). Furthermore, if any translations of documents 288 from their original language are used, the subject matter experts should agree that the selected translation is generally recognized as appropriate by the domain 290 itself.

In other embodiments, the number of documents 288 would not be capped so that a comprehensive corpus for each domain 290 could be established. Even where the number of documents 288 is not capped, the tool in the SME interface 206 would present proposed documents 288 for a vote among the subject matter experts to ensure that the documents 288 in the corpus are representative and varied.

While subject matter experts are assigned to individual domains 290 through subject matter expert entities 286, the voting on documents 288 for a domain 290 is explicitly not limited to those subject matter experts that are associated with that domain 290. By using subject matter experts outside of domain 290 to help identify documents 288 for domain 290, it is expected that a truer representative set of documents 288 will be created, as the outside subject matter experts will be less likely to bias the documents 288 for a particular sub-belief within the domain 290.

The set of documents 288 selected for a domain 290 by steps 1310-1330 is considered the database's “corpus” for the domain 290. The method 1300 shown in FIG. 13 then selects a next leaf-node domain 290 at step 1340, and then repeats steps 1310-1330 for the new domain 290. When all leaf-nodes in the domain hierarchy 292 have been assigned a corpus, the method 1300 ends. Although the flow chart representing method 1300 shows the assignment of documents 288 for domains 290 occurring serially, one domain 290 after another 290, it is to be expected that the process of assigning documents 288 for all domains 290 will happen in parallel, where documents 288 are being assigned to multiple domains 290 at once.

Method 1400, as shown in FIG. 14, allows the subject matter experts to define the snippets 282 for a domain 290. The method starts with step 1410, in which a life issue tag 270 is selected from the life issue tag hierarchy 272 established through method 1200. At step 1420, a leaf-node domain 290 is selected from the domain hierarchy 292 established through method 1100. At step 1430, a subject matter expert that is associated with the selected leaf-node domain 290 is asked to consider the life issue tag 270 selected at step 1410. The subject matter expert is requested to identify at least one snippet 282 from a document 288 in the corpus of their domain 290 that is applicable to, reflects upon, or is otherwise relevant to the selected life issue tag 270. Preferably, the subject matter experts will be requested to identify multiple snippets 282 from multiple documents 288 that reflect on the life issue tag 270. The subject matter expert may use their own knowledge of the corpus to select the snippets 282. Alternatively, the subject matter expert could perform scholarly research using the documents 288 that make up the corpus. Frequently a subject matter expert will have other scholarly tools available to them to perform this research, including indexes, concordances, scholarly papers, sermons, or even other experts. Many of these tools could be provided to the subject matter experts in automated form through the SME interface 206.

When the subject matter expert identifies a link between a snippet 282 from a document 288 and the selected life issue tag 270, step 1440 optionally verifies this association with other subject matter experts in the domain 290. This can be accomplished through the tools provide in the SME interface 206, and can require, for instance, a majority vote of all subject matter experts associated with a domain 290 before the association is considered verified. Alternatively, step 1440 can be skipped, with the method 1400 relying upon the expertise of the single subject matter expert that made the association. At step 1450, an idea database entity 280 is created in the database 260 to reflect this association. This new idea 280 links the selected life issue tag 270 with the snippet 282 that was selected by the subject matter expert. If this snippet 282 was not previously identified in the database 260, a new snippet database entity 282 is also created in step 1450 and associated with its source document 288. If the subject matter expert were able to identify multiple snippets 282 for a life issue tag 270, all of the identified snippets 282 would be subjected to steps 1440 and 1450.

At step 1460, the process 1400 determines if more domains 290 need to be examined for the selected life issue tag 270. If so, the process 1400 returns to step 1420 and the next domain 290 is selected for analysis. If not, step 1470 determines whether more life issue tags 270 remain in the hierarchy for analysis. If so, the process 1400 goes back to step 1410, where the next life issue tag 270 is selected. If the last life issue tag 270 has been analyzed, the process 1400 will end. Although FIG. 14 shows process 1400 as a serial process, where one life issue tag 270 and one domain 290 are analyzed at a time, one after another, in the real world the analysis of life issue tags 270 for each domain 290 would happen in parallel. All of the life issue tags 270 in the hierarchy 272 could be assigned to a subject matter expert for each domain 290 at a single time through the expert tools provided in the SME interface 206. As the subject matter experts completed their analysis for each life issue tag 270, the results would be returned to the database 260 and the appropriate idea database entities 270 and snippet database entities 282 would be created at that time. In addition, it is possible that a single life issue tag 270 would be assigned to multiple subject matter experts in a single domain 290. This would increase the accuracy and thoroughness of the assignment of ideas 280 to life issue tags 270 and snippets 282, although it would increase the workload for each subject matter expert.

Method 1400 combines the act of selecting a snippet 282 from the documents 288 and the assignment of life issue tags 270 to those snippets 282 into a single step. It does this by starting with the life issue tag 270, and then use subject matter experts to find associated snippets 282 for the tag. This is the preferred method for creating ideas 280 that linking life issue tags 270 and snippets 282. Methods 1500 and 1600, shown in FIGS. 15 and 16, respectively, present an alternative method of creating ideas 280. Method 1500 allows subject matter experts to define the snippets 282 for each document 288 independent of the life issue tags 270 that will be associated with the snippets 282. The method 1500 starts by gathering a variety of religious texts associated with a particular domain 290 in step 1510. While these texts could include documents 288 in the database 260, the texts could and preferably would include other spiritual texts as well. At step 1520, the system 100 analyzes these texts looking for citations to one of the documents 288 identified with a domain 290. If citations to a document 288 are found, suggested snippets based on those citations are created in step 1530. These steps 1510-1530 rely on the fact that the analyzed texts were likely written by religious scholars who have already scoured the documents 288 in the corpus of a domain 290 for meaning and have already identified some of the most important portions of these documents 288. If multiple ones of these texts cite the same small portion of a document 288, than it is likely that this portion would make a good snippet 282 for analysis in the archive database 260.

At step 1540, the system 100 also accepts suggestions for snippets 282 from users using the user interface 202. Users are frequently familiar with the contents of the documents 288 related to their own chosen domain 290, and are likely to have very valuable suggestions on excerpts that would make valuable snippets 282 and ideas 280. The suggested snippets from the automated analysis of other texts at step 1530 and the suggested snippets from users received at step 1540 are presented to subject matter experts via the SME interface 206 at step 1550 for validation. Using tools presented in the SME interface 206, subject matter experts can review the suggestions from steps 1530 and 1540 and validate those suggests that should be added to the archive database 260. These validations are received at step 1560. In addition, the subject matter experts may also have suggestions for snippets 282 which are also received by the system 100 through the SME interface 206 in step 1560. At step 1570, validated suggestions from step 1530 and 1540 are added as snippet database entities 282 in the database 260. Step 1570 also creates snippet database entities 282 for suggestions made directly by the subject matter experts. In one embodiment, only subject matter experts associated with the domain 290 at issue will receive access to suggested snippets and the ability to suggest new snippets at steps 1550 and 1560. This allows subject matter experts the ability to control the snippets 282 and resulting ideas 280 for the domain 290 for which they are experts. In other embodiments, all subject matter experts can participate in the validation of snippets 282 at steps 1550, 1560 for any domain 290.

As shown in database 260, every idea 280 is assigned to only a single life issue tag 270 and also to only a single snippet 282. However, it is likely that a single snippet 282 of a document 288 for a particular domain 290 will be relevant to multiple life issue tags 270. To accomplish this, multiple idea database entities 280 can be created which relate to the single snippet 282. In this way, the single snippet 282 can be associated with all of the relevant life issue tags 270 through their associated ideas 280.

FIG. 16 shows a method 1600 that can be used to assign life issue tags 270 to the snippets 282 identified in method 1500. The method 1600 starts by assuming that some of the snippets 282 were identified through the analysis of other texts in steps 1410-1430 described above. At step 1610 the citation to the snippet 282 from one of these analyzed texts is associated with the snippet and then used for linguistic analysis in step 1620. For instance, if a text by Martin Luther quoted a particular section of the Bible, that section may be identified as a snippet 282 in step 1420. At step 1610, the portion of Martin Luther's text is included with the snippet 282 for linguistic analysis in step 1620. The linguistic analysis is used to help identify a life issue tag 270 for that snippet 282. Via linguistic analysis, the text of the snippet 282 (as well citing portions from other texts) is analyzed and compared with the life issue tags 270 in an attempt to match the snippet 282 to a life issue tag 270.

In addition to matches made by the linguistic analysis at step 1620, the method 1600 also accepts suggested matches through the user interface 202 at step 1630. In this way, users of the database 260 can identify situations where a snippet 282 is relevant to a life issue tag 270 but is not yet the subject of an idea 280. The linguistic matches from step 1620 and the user suggestions from step 1630 are then presented to the subject matter experts via tools provided in the SME interface 206 at step 1640. The subject matter experts can review these proposed life issue tag 270 and snippet 282 pairings, verifying those pairings where the life issue tag 270 was relevant to the snippet 282 and rejecting poor or irrelevant suggestions. The tools presented through the SME interface 206 allow the subject matter experts to review the suggested pairings and submit their decisions back to the system 100. In addition, the same tools allow the subject matter experts to submit their own suggested pairings for review by other subject matter experts. In one embodiment, only subject matter experts in the relevant domain 290 are allowed to approve snippet 282 and life issue tags 270 pairings for that domain 290. The system 100 can be designed so that a majority of subject matter experts associated with a domain 290 must approve a pairing before the pairing is considered approved. In other embodiments, only a single subject matter expert is required to approve such a pairing before it is accepted by the system 100 in step 1650.

At step 1660, the system 100 creates a new idea 280 for each snippet 282 and life issue tag 270 pairing approved by the subject matter experts. The idea database entity 280 is created and associated with the appropriate life issue tag 270, snippet 282, and domain 290.

Method 1700, shown in FIG. 17, is used to assign commentaries 284 to the newly created ideas 280. Method 1700 can uses the ideas created either by method 1400 or by the combination of methods 1500 and 1600. At step 1710, a particular subject matter expert associated with the relevant domain 290 is requested to draft a commentary 284 for an idea 280. As explained above, a plurality of commentaries 284 are preferably created for each idea 280. These different commentaries 284 can each be assigned a different role 281. Step 1710 therefore assigns both an idea 280 and a role 281 to a subject matter expert for the creation of an appropriate commentary 284. This assignment is communicated using the tools provided by the SME interface 206. In some embodiments, the assignment is accomplished by selecting a subject matter expert database entity 286 for the relevant domain 290 and then communicating the assignment of that commentary to the subject matter expert associated with the selected database entity 286. That subject matter expert can accept or reject the assignment through the SME interface 206 at step 1720. If the subject matter expert rejects the assignment, a new assignment is made in step 1710. In other embodiments, the needed commentaries are presented to multiple subject matter experts (e.g., all subject matter experts associated with the relevant domain). Subject matter experts can view a list of commentaries 284 that need to be written, and then select one from the list at step 1720. When the subject matter expert selects that commentary 284, the commentary is assigned to the appropriate subject matter expert database entity 286 in the database 260 and is removed from the list of commentaries 284 available for other subject matter experts to accept. In yet another embodiment, subject matter expert database entities 286 are associated in the database with both a domain 290 and a role 281. In this embodiment, only a subject matter expert that is associated with a role 281 is permitted to draft a commentary 284 for that role 281.

The subject matter expert then drafts the commentary, and submits it back to the system 100 using the SME interface 206 in step 1730. At step 1740, the commentary 248 is added to the database 260 and associated with the idea 280. Because ideas 280 preferably always have the same number of commentaries filling all of the defined roles 281, ideas 280 that don't have commentaries 284 for all roles 281 can be considered incomplete. In some embodiments, incomplete ideas 280 are not released to the public, meaning that they cannot be accessed by users using the user interface 202. Step 1750 tracks the commentaries 284 associated with an idea 280, and releases the idea 280 for access by the user interface 202 only when enough commentaries 284 have been added to the database 260. This minimum number of commentaries 284 may be equal to the number of roles 281 defined by the system 100. In other embodiments, ideas 280 are released to the user interfaces 202 when fewer than all of the possible roles 281 have been filled.

After an idea 280 has been made public, user interaction with the ideas 280 is monitored by the system 100 at step 1760. As described above in connection with FIG. 10, users are allowed to vote positively or negatively for the comments 284 associated with an idea 280. If step 1760 identifies a particular comment 284 that has received negative user feedback, the system 100 can tag that commentary 284 for peer review by other subject matter experts at step 1770. If the peer review through the SME interface 206 indicates that the quality of the commentary 284 is insufficient for the database 260, that particular comment 284 can be withdrawn or deleted and the commentary 284 can be made available for re-writing at step 1710.

The many features and advantages of the invention are apparent from the above description. Numerous modifications and variations will readily occur to those skilled in the art. For example, idea database entities 280 are defined as distinct database structures separate from the snippet entities 282 and the commentary entities 284. It would be well within the scope of the present invention to combine the commentary entities 284 into the idea database entity 280. Furthermore, it would also be possible to combine the idea 280 and snippet 282 database entities into a single database structure containing an excerpt from a document 288. This combined structure could be viewed as snippet structure 282 and would still be associated with a document entity 288, a life issue tag entity 270, a domain entity 290, and a plurality of commentary entities 284. In fact, the combined snippet structure 282 could also incorporate the comments from the separate commentary entities 284 into its structure and still be functional as described above. Since such modifications are possible, the invention is not to be limited to the exact construction and operation illustrated and described. Rather, the present invention should be limited only by the following claims.

What is claimed is:

1. A server computing machine for spiritual research comprising:
a) a network interface providing data and a user interface to a remote computing device over a computerized network;
b) a processor that is controlled via programming instructions;
c) a non-transitory computer readable memory;
d) database programming stored on the non-transitory computer readable memory and performed by the processor, the database programming managing an archive database that is transformed during operation by the database programming, the archive database having:
i) a plurality of life issue tag database entities each having a life issue tag that identifies a life issue,
ii) a plurality of snippet database entities each having an excerpt from a source spiritual document,
iii) a plurality of subject matter expert database entities each identifying a subject matter expert,
iv) a plurality of commentary database entities each containing a commentary,
v) first database relationships between the commentary database entities and the subject matter expert database entities establishing a subject matter expert author for the commentary,
vi) second database relationships between the commentary database entities and the snippet database entities establishing an excerpt topic excerpt for the commentary, and
vii) third database relationships between the commentary database entities and the life issue tag database entities establishing a life issue for the commentary and
e) subject matter expert interface programming stored on the non-transitory computer readable memory and performed by the processor, the subject matter expert interface programming:
i) provides an SME interface to an identified subject matter expert over the network interface over the computerized network,
ii) indicates over the SME interface a particular excerpt and a particular life issue tag for which a new commentary is desired,
iii) receives the new commentary over the SME interface for the particular excerpt and the particular life issue, and
iv) stores the received commentary in a particular commentary database entity associated with the subject matter expert database entity for the identified subject matter expert.

2. The server computing machine of claim 1, wherein the server computing machine comprises a plurality of separate physical devices with separate processors, separate network interfaces, and separate non-transitory computer readable memories, the separate physical devices acting in concert as a single server computing machine according to the programming instructions.

3. The server computing machine of claim 1, wherein the archive database further comprises:
viii) a plurality of document database entities each identifying a spiritual document, and
ix) fourth database relationships between the snippet database entities and the document database entities establishing the source spiritual document for the excerpt.

4. The server computing machine of claim 3, wherein the archive database further comprises:
x) a plurality of domain database entities each identifying a spiritual domain, and
xi) fifth database relationships between the commentary database entities and the domain database entities establishing the spiritual domain for the commentary,
x) sixth database relationships between the subject matter expert database entities and the domain database entities establishing an expert spiritual domain for which the subject matter expert is an expert.

5. The server computing machine of claim 4, wherein the subject matter expert interface programming further:
v) provides the SME interface to a plurality of subject matter experts associated with a plurality of spiritual domains within the archive database, and
vi) receives an assignment indication over the SME interface associating a plurality of document database entities with a particular domain database entity.

6. The server computing machine of claim 5, wherein the archive database further comprises:
xi) seventh database relationships between the document database entities and the domain database entities establishing a spiritual domain for a document;
wherein a particular document database entity is associated with the particular domain database entity when a plurality of assignment indications have been received for that association from subject matter experts associated with a plurality of domains; further wherein the document database entities associated with the particular domain database entity constitutes a corpus for the particular spiritual domain for the particular domain database entity with the corpus containing canonical texts and contemporary texts representative of divisions within the particular spiritual domain.

7. The server computing machine of claim 6, wherein the domain database entities include family relationships defining a domain hierarchy having a plurality of leaf domain database entities identifying leaf spiritual domains.

8. The server computing machine of claim 7, wherein fifth and seventh database relationships only assign leaf spiritual domains for commentaries and documents, respectively, and do not assign spiritual domains that are not leaf spiritual domains to commentaries and documents.

9. The server computing machine of claim 1, wherein second database relationships further establishes a role for the commentary, the role taken from a set of roles have a pre-established number of roles in the set of roles, wherein the subject matter expert interface programming further indicates over the SME interface a particular role as well as the particular excerpt and the particular life issue tag for which commentary is desired, further wherein the particular commentary database entity further identifies the particular role.

10. The server computing machine of claim 9, wherein the archive database further comprises:
vii) a plurality of idea database entities, and
viii) database relationships associating each idea database entity with a single life issue tag database entity, a single snippet database entity, a single domain database entity, and a plurality of commentary database entities with each commentary database entity associated with the single idea database entity having a different role.

11. A method of providing access to spiritual research data over a network comprising:
a) at a server computer, providing access to an identified user to the database via a user interface;
b) at the server computer, providing access through the user interface to an archive database containing:
i) life issue tags, and
ii) ideas, with each idea associated with a single life issue tag, the ideas each having an excerpt from a spiritual document, and at least one commentary reflecting on the excerpt in the context of the associated life issue tag;
c) at the server computer, receiving via the user interface a search request from the identified user;
d) at the server computer, comparing the search request to synonyms previously assigned to the life issue tags; and
e) at the server computer, monitoring actions of the identified user through the user interface after receiving the search request;
f) at the server computer, identifying a desired life issue tag different from the found life issue tag based on the monitored actions; and
g) at the server computer, assigning the search request as a new synonym to the desired life issue tag.

12. The method of claim 11, wherein the step of assigning the search request as the new synonym further comprises:
i) suggesting the search request as a new synonym to a subject matter expert through a subject matter interface, and
ii) receiving confirmation of synonym assignment through the subject matter expert interface.

13. A method of providing access to spiritual research data over a network comprising:
a) establishing at a server computer a database having domain database entities;
b) receiving, at the server computer and through a subject matter expert (SME) interface, suggestions for spiritual domains to be added to the database;
c) at the server computer, establishing within the database domain database entities for the suggested spiritual domains,
d) receiving, at the server computer and through the SME interface, a suggested domain hierarchy for the spiritual domains; and
e) at the server computer, establishing within the database the suggested domain hierarchy as a hierarchy of domain database entities.

14. The method of claim 13 further comprising:
f) at the server computer, establishing within the database life issue tag database entities;
g) receiving, at the server computer and through the SME interface, suggestions for life issue tags,
h) at the server computer, establishing within the database life issue tag database entities for the suggested life issue tags,
i) receiving, at the server computer and through the SME interface, a suggested life issue tag hierarchy for the life issue tags
j) at the server computer, establishing within the database the suggested life issue tag hierarchy as a hierarchy of life issue tag database entities,
k) receiving, at the server computer and through a user interface, a suggested change to the life issue tag hierarchy;
l) at the server computer, submitting the suggested change to the life issue tag hierarchy to the SME interface for confirmation; and
m) at the server computer and upon receipt of the confirmation from the SME interface, updating the database to reflect the suggested change to the life issue tag hierarchy.

15. A method for using subject matter experts to establish a spiritual database comprising:
a) establishing the spiritual database as a structured, computerized archive database managed by a server computing system;
b) at the server computing system, establishing in the archive database a plurality of domain database entities each identifying a different spiritual domain;
c) at the server computing system, establishing in the archive database a domain hierarchy of the domain database entities having leaf nodes;
d) at the server computing system, establishing in the archive database document database entities identifying spiritual documents;
e) at the server computing system, assigning in the archive database the document database entities to the leaf nodes in the domain hierarchy;
f) at the server computing system, receiving expert-identified excerpts from the spiritual documents through an SME interface used by the subject matter experts; and
g) establishing snippet database entities identifying the expert-identified excerpts from the documents.

16. The method of claim 15, further comprising:
h) at the server computing system, analyzing additional documents for citations to the spiritual documents to identify potential excerpts from the spiritual documents;
i) at the server computing system, submitting the potential excerpts for verification to the SME interface,
j) upon verification through the SME interface, establishing snippet database entities identifying the potential excerpts.

17. The method of claim 15, further comprising:
h) at the server computing system, receiving user-identified excerpts from a user interface,
i) at the server computing system, submitting the user-identified excerpts for verification to the SME interface; and
j) at the server computing system and upon verification through the SME interface, establishing in the archive database snippet database entities identifying the user-identified excerpts from the documents.

18. The method of claim 15, further comprising:
h) at the server computing system, establishing in the archive database a plurality of life-issue tag database entities;
i) at the server computing system, establishing in the archive database a plurality of idea database entities;
j) at the server computing system, establishing in the archive database associations between each idea database entity and one snippet database entity, one life issue tag database entity, and one domain database entity;
k) at the server computing system, indicating over the SME interface a need for a new commentary for a particular idea database entity;
l) at the server computing system, receiving over the SME interface the new commentary for the particular idea database entity, and
m) at the server computing system, establishing in the archive database:
i) a commentary database entity containing the new commentary, and
ii) a relationship associating the commentary database entity with the particular idea database entity.

19. The method of claim 18, further comprising:
n) at the server computing system, tracking a total number of commentary database entities associated with each idea database entity;
o) at the server computing system, releasing idea database entities for research over a user interface only after the total number of commentary database entities for the idea database entities exceeds a minimum threshold.

20. The method of claim 19, wherein the step of indicating a need for a new commentary further comprises indicating a role for the new commentary, further wherein archive database identifies the role for the commentary database entity containing the new commentary.

21. The method of claim 20, further comprising:
p) at the server computing system, receiving over the user interface user-ratings of the new commentary; and
q) at the server computing system, using the user-ratings to sort commentaries presented over the user interface.

22. The method of claim 21, further comprising:
r) flagging the new commentary for peer-review on receipt of a plurality of negative user-ratings for the new commentary.
